(19) United States
(12) Patent Application Publication
(10) Pub. No.: US 2025/0045396 A1
(43) Pub. Date: Feb. 6, 2025

(54) ATTACK ANALYSIS DEVICE, ATTACK ANALYSIS METHOD, AND STORAGE MEDIUM

(71) Applicant: DENSO CORPORATION, Kariya-city (JP)

(72) Inventors: Keigo NAGARA, Kariya-city (JP); Taiji ABE, Kariya-city (JP); Tomonori IKUSE, Kariya-city (JP); Keita HAYAKAWA, Kariya-city (JP); Masumi EGAWA, Kariya-city (JP)

(21) Appl. No.: 18/776,308

(22) Filed: Jul. 18, 2024

(30) Foreign Application Priority Data
Jul. 31, 2023 (JP) 2023-124143

(51) Int. Cl. G06F 21/56

(52) U.S. Cl. CPC G06F 21/566; G06F 2221/034

(57) ABSTRACT

An attack analysis device stores attack abnormality relationship information indicating a relationship among (i) predicted attack information indicating an attack predicted to be received by an electronic control system, (ii) predicted abnormality information indicating an abnormality predicted to occur in response to the predicted attack, and (iii) predicted abnormality location information indicating a location within the electronic control system where the predicted abnormality occurs. The attack analysis device is configured to: acquire a security log indicating an abnormality detected in the electronic control system and a detection location of the abnormality in the electronic control system; estimate the attack based on the security log and the attack abnormality relationship information; analyze an estimation accuracy of the attack based on context data included in the security log; and output attack information, which indicates the estimated attack, and estimation accuracy information, which indicates the estimation accuracy of the attack.

### CROSS REFERENCE TO RELATED APPLICATION

The present application claims the benefit of priority from Japanese Patent Application No. 2023-124143 filed on Jul. 31, 2023. The entire disclosure of the above application is incorporated herein by reference.

### TECHNICAL FIELD

The present disclosure relates to a technique for analyzing an attack on an electronic control system mounted on a machine, such as a vehicle or other moving objects. The present disclosure relates to an attack analysis device, an attack analysis method, and a storage medium storing an attack analysis program.

### BACKGROUND

Conventionally, driving assistance technology and automated driving control technology are executed using vehicle-to-vehicle communication or roadside-to-vehicle communication. The vehicle-to-vehicle communication or roadside-to-vehicle communication is known as vehicle to everything (V2X) communication.

### SUMMARY

The present disclosure provides an attack analysis device. The attack analysis device stores attack abnormality relationship information indicating a relationship among (i) predicted attack information indicating an attack predicted to be received by an electronic control system, (ii) predicted abnormality information indicating an abnormality predicted to occur when the electronic control system receives the predicted attack, and (iii) predicted abnormality location information indicating a location within the electronic control system where the predicted abnormality occurs. The attack analysis device is configured to: acquire a security log indicating an abnormality detected in the electronic control system and a location within the electronic control system where the abnormality is detected; estimate the attack received by the electronic control system based on the security log and the attack abnormality relationship information; analyze an estimation accuracy of the attack received by the electronic control system based on context data included in the security log; and output attack information, which indicates the estimated attack, and estimation accuracy information, which indicates the estimation accuracy of the attack.

### BRIEF DESCRIPTION OF DRAWINGS

Objects, features and advantages of the present disclosure will become apparent from the following detailed description made with reference to the accompanying drawings. In the drawings:

FIG. 1A, FIG. 1B, and FIG. 1C are explanatory diagrams each showing a positional relationship between an attack analysis device and an electronic control system according to each embodiment;

FIG. 2 is a block diagram showing a configuration example of an electronic control system;

FIG. 3 is an explanatory diagram showing contents of a security log;

FIG. 4 is a block diagram showing an example of a configuration of the attack analysis device according to an embodiment;

FIG. 5 is an explanatory diagram showing an example of attack abnormality relationship information;

FIG. 6 is an explanatory diagram showing another example of attack abnormality relationship information;

FIG. 7 is an explanatory diagram for explaining an operation of a reference attack factor information estimation unit and an attack estimation accuracy analysis unit according to a first embodiment;

FIG. 8 is an explanatory diagram for explaining an operation of a reference attack factor information estimation unit and an attack estimation accuracy analysis unit according to a second embodiment;

FIG. 9A is an explanatory diagram for explaining an operation of a reference attack factor information estimation unit and an attack estimation accuracy analysis unit according to a third embodiment;

FIG. 9B is an explanatory diagram for explaining context data related information used in a modified example of the third embodiment;

FIG. 10 is an explanatory diagram for explaining an operation of a reference attack factor information estimation unit and an attack estimation accuracy analysis unit according to a fourth embodiment;

FIG. 11A is an explanatory diagram for explaining an operation of a reference attack factor information estimation unit and an attack estimation accuracy analysis unit according to a fifth embodiment;

FIG. 11B is an explanatory diagram for explaining an operation of a reference attack factor information estimation unit and an attack estimation accuracy analysis unit according to a modified example of the fifth embodiment;

FIG. 12 is an explanatory diagram for explaining an operation of a reference attack factor information estimation unit and an attack estimation accuracy analysis unit according to a sixth embodiment; and

FIG. 13 is a flowchart showing an operation of the attack analysis device according to an embodiment.

### DETAILED DESCRIPTION

In recent years, driving assistance technology and automated driving control technology, such as vehicle-to-vehicle communication and roadside-to-vehicle communication, which are known as vehicle to everything (V2X), have been attracting attention. With the attention on the driving assistance technology and automated driving technology, vehicles are equipped with communication function, that is, connectivity of vehicles is progressing. Since the vehicles are equipped with communication function, a probability that a vehicle may receive a cyberattack, that is, unauthorized access is increasing. Therefore, it is necessary to analyze the cyberattack on vehicles and to construct countermeasures against the cyberattack.

There are various technologies for detecting abnormalities occurred in vehicles and analyzing cyberattack based on the detected abnormalities. A related art discloses a method of collecting detected abnormality data and specifying a type of attack corresponding to the abnormality by comparing (i) combination of items in which abnormalities are detected with (ii) an abnormality detection pattern previously specified for each attack.

The inventors of the preset disclosure have found the following difficulties.

An attack on the electronic control system may be estimated using (i) a security log indicating an abnormality detected in the electronic control system and a location in the electronic control system where the abnormality is detected, and (ii) attack abnormality relationship information indicating combinations of abnormalities estimated to be occurred when the electronic control system receives the cyberattack. In this case, an attack type candidate having a low probability with respect to the actual attack may be included in the estimated attack type. Furthermore, when such attack type candidate is included in the estimated attack type, if all candidates are evaluated equally, a measure that is not appropriate for the actual cyberattack may be selected as a measure against the cyberattack.

According to an aspect of the present disclosure, an attack analysis device, which analyzes an attack on an electronic control system mounted on a moving object, includes: a log acquisition unit acquiring a security log indicating an abnormality detected in the electronic control system and a location within the electronic control system where the abnormality is detected; an attack abnormality relationship information storage storing attack abnormality relationship information indicating a relationship among (i) predicted attack information indicating an attack predicted to be received by the electronic control system, (ii) predicted abnormality information indicating an abnormality predicted to occur when the electronic control system receives the predicted attack, and (iii) predicted abnormality location information indicating a location within the electronic control system where the predicted abnormality occurs; an attack estimation unit estimating the attack received by the electronic control system based on the security log and the attack abnormality relationship information; an attack estimation accuracy analysis unit analyzing an estimation accuracy of the attack received by the electronic control system based on context data included in the security log; and an output unit outputting attack information, which indicates the estimated attack, and estimation accuracy information, which indicates the estimation accuracy of the attack.

According to another aspect of the present disclosure, an attack analysis method and attack analysis program corresponding to the above-described attack analysis device are provided.

As described above, the attack analysis device according to the present disclosure analyzes the estimation accuracy of attack using context data included in the security log and outputs the analysis result as estimation accuracy information. Thus, the attack analysis device can use the attack estimation result with consideration of the accuracy of estimated result of cyberattack.

Exemplary embodiments of the present disclosure will be described below with reference to the drawings.

Effects described in embodiments may be effects obtained by a configuration of an exemplary embodiment of the present disclosure, and may not be necessarily effects of the present disclosure.

When there are multiple embodiments (including modifications), the configurations disclosed in the embodiments are not limited to the embodiments, and can be combined across the embodiments. For example, the configuration disclosed in one embodiment may be combined with another embodiment. The disclosed configurations in respective embodiments may be partially combined with one another.

### 1. Premise Configuration in Each Embodiment

### (1) Positional Relationship Between Attack Analysis Device 10 and Electronic Control System S

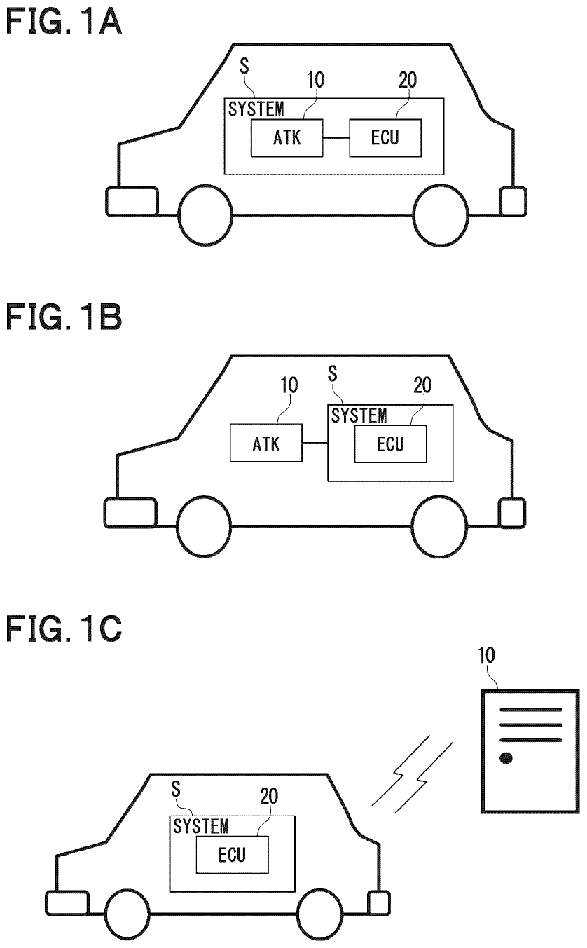

The positional relationship between an attack analysis device 10 and an electronic control system S in each embodiment will be described with reference to FIG. 1A to FIG. 1C. In FIG. 1A to FIG. 1C, the attack analysis device 10 is indicated as ATK, the electronic control system is indicated as S.

The attack analysis device 10 analyzes an attack on the electronic control system S. More specifically, the attack analysis device receives a security log generated by a security sensor of an electronic control device 20, which constitutes the electronic control system S, and analyzes the attack on the electronic control system S based on the security log.

As shown in FIG. 1A and FIG. 1B, the attack analysis device 10 may be mounted on a vehicle, which corresponds to a moving object, together with the electronic control device 20 that constitutes the electronic control system S. As shown in FIG. 1C, the attack analysis device 10 may be implemented as a server device or security operation center (SOC) located outside the vehicle. Hereinafter, the electronic control device 20 may be referred to as electronic control unit (ECU) 20.

Here, the moving object refers to a movable object, and a movement speed is arbitrary.

The moving object may include a moving object which is in a stopped state. Examples of the moving object include, but are not limited to, an automobile, a motorcycle, a bicycle, a pedestrian, a ship, an aircraft, and an object mounted thereon.

The term “mounted” includes not only a case where an object is directly fixed to the moving object but also a case where an object is moved together with the moving object although the object is not fixed to the moving object. Examples of the object include an object carried by a user who is in the moving object and an object attached to a load carried by the moving object.

FIG. 1A shows an example in which the attack analysis device 10 is independently provided inside the electronic control system S, or an example in which the functions of the attack analysis device 10 are built in at least one of the ECUs 20 that constitute the electronic control system S. FIG. 1B shows an example in which the attack analysis device 10 is provided outside the electronic control system S. From the viewpoint of the connection form, it is substantially the same as FIG. 1A.

In the configurations of FIG. 1A and FIG. 1B, the attack analysis device 10 and the ECU 20 are connected via an in-vehicle communication network, such as a Controller Area Network (CAN) or a Local Interconnect Network (LIN). Alternatively, the attack analysis device 10 and the ECU 20 may be connected via any communication method, whether wired or wireless, such as Ethernet (registered trademark), Wi-Fi (registered trademark), or Bluetooth (registered trademark). The term “connection” refers to a state in which data can be exchanged. This state includes a case in which different hardware devices are connected through a wired or wireless communication network, as well as a case in which virtual machines running on the same hardware are virtually connected with one another.

FIG. 1C shows an example in which the attack analysis device 10 is provided outside the electronic control system S. Further, the attack analysis device 10 is provided outside the vehicle. Thus, the connection form is different from the connection form of FIG. 1A and FIG. 1B. The attach analysis device 10 and the electronic control system S may be connected via a communication network adopting a wireless communication method of IEEE 802.11 (Wi-Fi, registered trademark), IEEE 802.16 (WiMAX, registered trademark), wideband code division multiple access (W-CDMA), high speed packet access (HSPA), long term evolution (LTE), long term evolution advanced (LTE-A), 4G, or 5G. Alternatively, the attach analysis device 10 and the electronic control system S may be connected via a dedicated short range communication (DSRC). When the vehicle is parked in a parking lot or accommodated in a repair shop, a wired communication method can be used instead of the wireless communication method. For example, a local area network (LAN), the internet, or a fixed telephone line can be used for the communication.

In the configurations of FIG. 1A and FIG. 1B, the cyberattack can be analyzed without communicating with an external device. Thus, the configurations of FIG. 1A and FIG. 1B enables the cyberattack analysis without delay within the attacked vehicle, thereby enabling rapid response to the cyberattack.

In the configuration of FIG. 1C, it is possible to analyze the cyberattack by utilizing a sufficient resource of a server device. Further, the cyberattack analysis can be performed centrally on the server device without installing new devices or programs in the existing vehicles.

Hereinafter, the embodiments will be described with the configuration shown in FIG. 1C as a premise.

In each embodiment, a vehicle system equipped to a vehicle will be described as an example of the electronic control system S. However, the electronic control system S is not limited to a vehicle system, and may be applied to any kind of electronic control system including multiple ECUs. For example, the electronic control system S may be equipped to a stationary object or a fixed object instead of a moving object.

A part of the attack analysis device 10 may be provided in the server device, and the remaining part may be provided in the moving object or other devices.

The attack analysis device 10 determines whether the abnormality indicated in the received security log is an abnormality caused by a cyberattack or an abnormality caused by a reason other than a cyberattack. In response to determining that the abnormality is caused by a cyberattack, the attack analysis device analyzes the cyberattack based on the security log. In response to determining that the abnormality is caused by a reason other than a cyberattack, the attack analysis device 10 determines that the security log is a false positive log and does not analyze the cyberattack. A unit having such a function can be defined as a log determination device.

The process executed by the log determination device may be provided at a stage before the process executed by the attack analysis device 10. The log determination device may be included in the attack analysis device 10. Although not shown in the drawings, in the configurations of FIG. 1A and FIG. 1B, the log determination device is also mounted on the vehicle. In the configuration of FIG. 1C, the log determination device may be provided in the server device, which corresponds the attack analysis device 10. Alternatively, the log determination device may be provided in the vehicle.

### (2) Configuration of Electronic Control System S

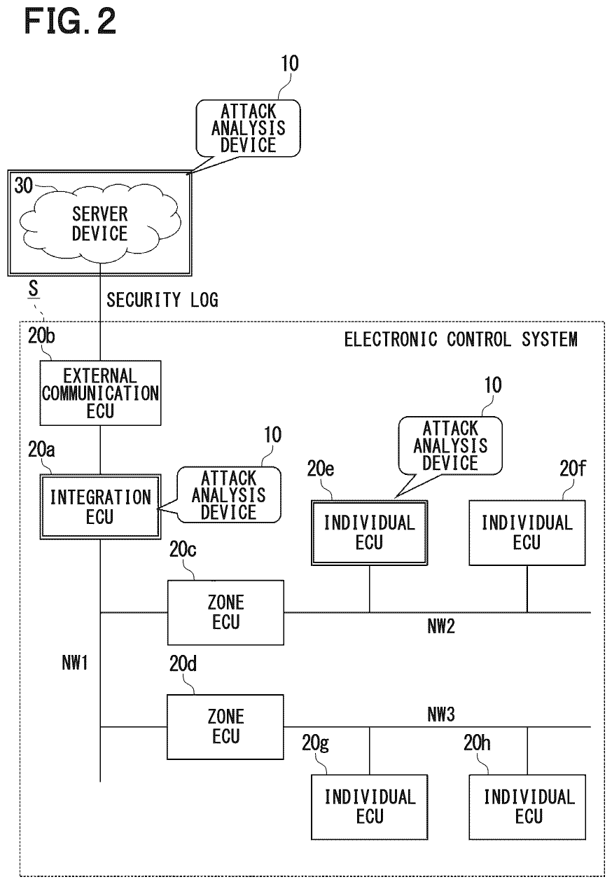

FIG. 2 is a diagram showing a configuration example of the electronic control system S. The electronic control system S includes multiple ECUs 20 and in-vehicle networks NW1, NW2, NW3 for connecting the multiple ECUs 20. Although FIG. 2 illustrates eight ECUs (ECUs 20a to 20h), it is obvious that the electronic control system S may include any number of ECUs. In the following description, the ECU 20 and the ECUs 20 are described comprehensively for a single or multiple electronic control units, and the ECU 20a, ECU 20b, ECU 20c, . . . are described when individual electronic control units are specifically described.

In the configuration of FIG. 2, the ECUs 20 are connected with one another via the in-vehicle communication network described in the explanation of FIG. 1A and FIG. 1B.

The electronic control system S illustrated in FIG. 2 includes an integration ECU 20a, an external communication ECU 20b, zone ECUs 20c, 20d, and individual ECUs 20e, 20f, 20g, 20h.

The integration ECU 20a is an ECU having a function of controlling the entire electronic control system S and a gateway function of mediating communication among the ECUs 20. The integration ECU 20a may be referred to as a gateway ECU (G-ECU) or a mobility computer (MC). The integration ECU 20a may be a relay device or a gateway device.

The external communication ECU 20b includes a communication unit that communicates with an external device located outside the vehicle, for example, a server device 30 to be described in each embodiment. A communication method adopted by the external communication ECU 20b is the wireless communication method or the wired communication method described in the explanation of FIG. 1C.

In order to implement multiple communication methods, the electronic control system S may include multiple external communication ECUs 20b. Instead of providing the external communication ECU 20b, the integration ECU 20a may have a function of the external communication ECU 20b.

Each zone ECU 20c, 20d has a gateway function provided according to a function or a location where each individual ECU is arranged. The individual ECUs will be described later. For example, the zone ECU 20c has a gateway function of relaying communication between the individual ECU 20e, 20f disposed in a front region of the vehicle and another ECU 20. The zone ECU 20d has a gateway function of relaying communication between the individual ECU 20g, 20h disposed in a rear region of the vehicle and another ECU 20. The zone ECUs 20c, 20d may be referred to as domain computers (DC). The individual ECU 20e and the individual ECU 20f are connected to the zone ECU 20c via the network 2 (NW2). The individual ECU 20g and the individual ECU 20h are connected to the zone ECU 20d via the network 3 (NW3).

The individual ECUs 20e, 20f, 20g, 20h can be implemented by ECUs having any function. Examples of individual ECUs include a drive system electronic control unit that controls an engine, a steering wheel, a brake, and the like, a vehicle body system electronic control unit that controls a meter, a power window, and the like, an information system electronic control unit such as a navigation device, and a safety control system electronic control unit that performs control for preventing a collision with an obstacle or a pedestrian. The ECUs may be classified into a master and a slave instead of parallel arrangement.

In addition, necessary sensors may be connected to each of the individual ECUs 20e, 20f, 20g, 20h depending on the functions provided by each individual ECU. Examples of the sensor include, but are not limited to, a speed sensor, an acceleration sensor, an angular velocity sensor, a temperature sensor, a seat sensor, and a voltmeter. These sensors may be connected to the integration ECU 20a or the zone ECUs 20c, 20d instead of to the individual ECUs 20e, 20f, 20g, 20h.

Each ECU 20 may be a physically independent electronic control unit, or may be a virtual electronic control unit implemented by using a virtualization technology. When the ECUs 20 are implemented on different hardware, the ECUs 20 may be connected via a wired or wireless communication method. When multiple ECUs 20 are implemented in virtual manner using the virtualization technology on a single hardware, the virtual ECUs may be connected with one another in virtual manner.

In the configuration of FIG. 1A, the attack analysis device 10 is provided inside the electronic control system S. For example, as shown in FIG. 2, the attack analysis device 10 may be implemented by the integration ECU 20a or by the individual ECU 20e. When the attack analysis device 10 is implemented by the individual ECU 20e, the individual ECU 20e may be an ECU having dedicated purpose as the attack analysis device 10.

In the configuration of FIG. 1C, the attack analysis device 10 is provided outside the electronic control system S, and the attack analysis device may be implemented by the server device 30 as shown in FIG. 2. In this case, the server device 30 receives the security log transmitted by the external communication ECU 20b.

Each ECU 20 has a security sensor. When the security sensor detects an abnormality occurrence in the ECU 20 or in the network connected to the ECU 20, the security sensor generates a security log. Details of security logs will be explained later. It is not necessary for all the ECUs 20 to be equipped with a security sensor.

### (3) Details of Security Log

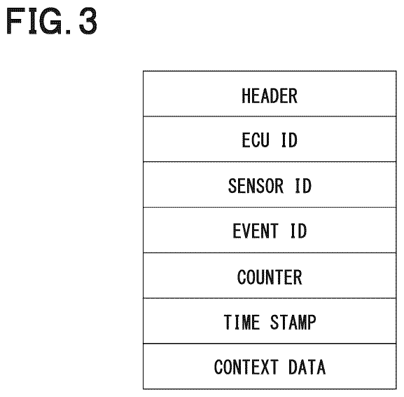

FIG. 3 is a diagram showing contents of a security log generated by the security sensor of the ECU 20.

The security log has the following data fields: an ECU ID indicating identification information of the ECU in which the security sensor is installed; a sensor ID indicating identification information of a target monitored by the security sensor; an event ID indicating identification information of an event related to an abnormality detected by the security sensor; a counter indicating the number of times the event has occurred; a timestamp indicating occurrence time of the event; and context data indicating details of the security sensor output. The security log may further include a header storing information indicating a protocol version and a state of each data field.

According to the specifications defined by AUTOSAR (AUTomotive Open System ARchitecture), IdsM Instance ID defined in AUTOSAR corresponds to ECU ID, Sensor Instance ID defined in AUTOSAR corresponds to the sensor ID, Event Definition ID defined in AUTOSAR corresponds to the event ID, Count defined in AUTOSAR corresponds to the counter, Timestamp defined in AUTOSAR corresponds to the timestamp, Context Data defined in AUTOSAR corresponds to the context data, Protocol Version and Protocol Header defined in AUTOSAR correspond to the header, respectively.

The context data shown in FIG. 3 is collected and stored when an abnormality is detected, and includes information related to the frame or network in which the abnormality is occurred or other information related to the abnormality. For the counter, timestamp, and header shown in FIG. 3, information related to abnormalities are also collected and stored. Thus, these are also included in the “context data.”

An example of data included in the context data shown in FIG. 3 is communication direction information indicating a source and/or destination of a communication, such as a packet in which an abnormality is detected. The communication direction information does not necessarily need to indicate the final destination of the communication, and the source or destination may indicate a relay point. Examples of communication direction information include an IP address, a MAC address, a message ID, a CAN ID, and a port number.

Other examples of context data include a rule type of the sensor, an error type, a severity, a communication content, and an identifier and content indicating detected file or process software, etc. Other examples include filtering information of output result, travel distance, time, electric power status, vehicle status information, and security sensor version.

The following will describe how each context data is used in each embodiment.

FIG. 3 is an example of the log generated in response to occurrence of abnormality. A normal log generated when no abnormality occurs (for example, a case where an event is successful) may have the same configuration as in FIG. 3. In such a case, different event IDs may be used for an event in which an abnormality is occurred and an event in which no abnormality is occurred in order to distinguish the abnormal log from the normal log. Alternatively, by setting, in the header, a flag indicating the presence or absence of context data, the abnormal log may be distinguished from the normal log by checking the flag.

FIG. 3 shows a security log generated by a physically independent ECU 20. The security log may be generated by a virtual ECU.

The security log generated by the security sensor is represented as SEv, and a qualified and accurate security log is represented by QSEv (qualified SEv). For example, the security sensor of the individual ECU 20e, 20f, 20g, 20h shown in FIG. 2 generates security log SEv and reports it to an intrusion detection system manager (IdsM), which is not shown. When the one or more security log SEv passes a filter chain and meets specified criteria in the IdsM, the one or more security log SEv is transmitted as QSEv from an intrusion detection reporter to the outside of the vehicle. The security log in the present embodiment is a concept including both of the SEv and the QSEv.

The security log in each embodiment may be a log generated by a function known as in-vehicle Security Information and Event Management (SIEM). SIEM collects and manages information related to events occurred in the electronic control system.

### 2. Embodiments

### (1) Configuration of Attack Analysis Device 10

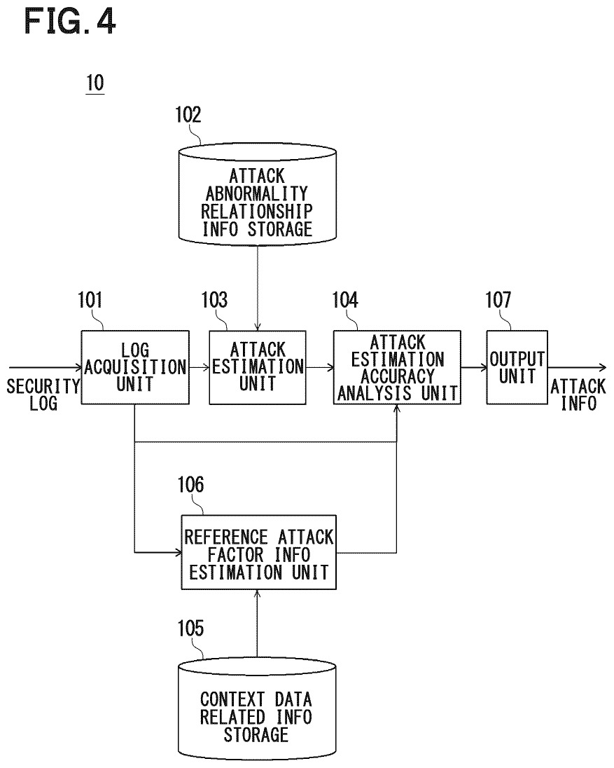

The configuration of attack analysis device 10 will be described with reference to FIG. 4. The attack analysis device 10 includes a log acquisition unit 101, an attack abnormality relationship information storage 102, an attack estimation unit 103, an attack estimation accuracy analysis unit 104, a context data related information storage 105, a reference attack factor information estimation unit 106, and an output unit 107.

The log acquisition unit 101 acquires a security log that indicates an abnormality detected in the electronic control system S and the location within the electronic control system S where the abnormality is detected. For example, when the security log of FIG. 3 is received, the type of abnormality is indicated in the event ID and context data, and the location where the abnormality was detected is indicated in the ECU ID and the sensor ID. The type of abnormality may be indicated by the sensor ID, or the location where the abnormality is detected may be indicated by the sensor ID.

In the present disclosure, “acquire” includes not only a device or block acquiring by receiving information or data transmitted from another device or block, but also a device or block acquiring by this device or block generating information or data.

The attack abnormality relationship information storage 102 stores an attack abnormality relationship table (corresponding to “attack abnormality relationship information”) that indicates a relationship between a cyberattack and an abnormality occurred in the electronic control system S. The attack abnormality relationship table shows the relationship between predicted attack information indicating an attack that the electronic control system S may receive, predicted abnormality information indicating an abnormality predicted to occur in response to the received attack, and predicted abnormality location information indicating the location within the electronic control system where the predicted abnormality may occur.

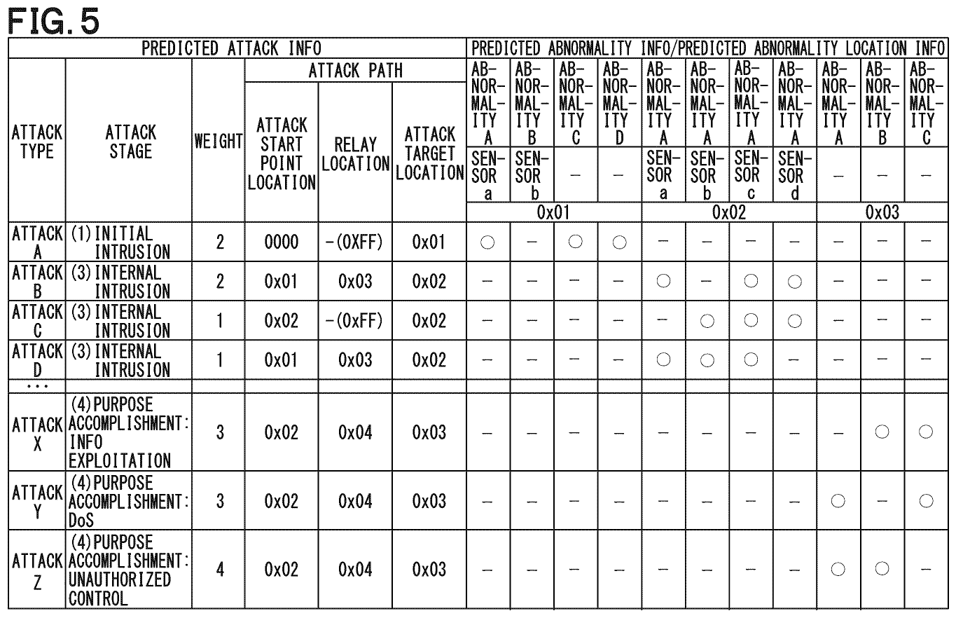

FIG. 5 is a diagram for explaining the attack abnormality relationship table used in each embodiment.

The attack abnormality relationship table shown in FIG. 5 shows, for each type of cyberattack (attacks A to Z) (corresponding to “predicted attack information”), the abnormalities (corresponding to “predicted abnormality information”) that are predicted to occur when the electronic control system S receives each type of cyberattack, and the location where the predicted abnormalities may occur (corresponding to “predicted abnormality location information”). When a cyberattack is received, multiple types of abnormalities may occur at one or more locations. Therefore, the attack abnormality relationship table indicates combinations of multiple abnormalities occurred in response to the reception of cyberattack and the locations where the respective abnormalities occur.

In FIG. 5, the predicted attack information includes predicted attack factor information, in addition to the type of cyberattack (attacks A to Z). The predicted attack factor information includes an attack stage, weight, and an attack path.

The attack path includes a start point location of the attack, a relay location, and a target location of an attack when the cyberattack is received. The configuration of attack path is described as one example. In another example, the attack path may include only the start point location of the attack. Alternatively, the attack path may include only the target location of the attack. Alternatively, the attack path may include only the start point location and the target location of the attack.

The attack stage indicates an intrusion stage of attack in the electronic control system S. The intrusion stage is classified into, in order of increasing level of intrusion, the following categories: inspection, initial intrusion, base construction, internal intrusion, and purpose accomplishment. The content of the purpose, a target of the attack, or an execution manner of the attack may be specified in the purpose accomplishment and execution of attack. For example, such subcategory as a springboard attack, information theft, DOS attack, and unauthorized control may be added.

Weight may be set for each attack type based on (i) whether the attack type occurs frequently, (ii) whether the attack affects important location, or (iii) whether the attack is currently occurring on a host vehicle or another vehicle.

The attack information output from the output unit 107 is information estimated based on the predicted attack information included in the attack abnormality relationship table, Thus, the attack abnormality relationship table having predicted attack information including factor information required to be included in the attack information may be used.

FIG. 5 shows abnormalities A to D as predicted abnormality information. The predicted abnormality information is predicted information corresponding to an abnormality indicated by an event ID included in the security log.

In FIG. 5, sensors a to d and locations 0x01 to 0x03 immediately below them are shown as examples of predicted abnormality location information. The predicted abnormality location information corresponds to the sensor type indicated by the sensor ID included in the security log and the ECU type indicated by the ECU ID included in the security log.

In FIG. 5, each of the predicted abnormality location, the attack start point location, the relay location, and the attack target location is indicated by an identifier expressed in hexadecimal number. Herein, each identifier indicates a location address. The sensor type is exception of the identifier expressed in hexadecimal number. The location corresponding to the identifier may be a concrete location or an abstract location. Specific examples of the location include the type of each ECU 20 and the type of security sensor. As an example of the type of an ECU 20, 0x00 indicates an external location, 0x01 indicates an external communication ECU 20b, 0x02 indicates an integration ECU 20a, 0x03 indicates a zone ECU 20c, and 0x04 indicates an ECU 20e. Examples of the abstract location of an ECU include where the ECU is located in a hierarchy a network to which the ECU 20 is connected, and functions and characteristics of the ECU 20. Note that 0xFF means null, or no match.

In FIG. 5, for example, when the electronic control system S receives a cyberattack of type A, it is predicted that the abnormality A may occur in the sensor a of the external communication ECU 20b and the abnormalities C and D may occur in the external communication ECU 20b. In FIG. 5, the attack A is in the initial intrusion stage, has a weight of 2, has an attack start point outside the electronic control system S, has no relay location, and has an attack target location in the external communication ECU 20b. The attack start point location may be a location inside the electronic control system S or may be outside the electronic control system S. When the attack start point location is outside the electronic control system S, the received cyberattack has started from the outside of the vehicle.

The attack abnormality relationship table shown in FIG. 5 is shown in a table format. The data about attack abnormality relationship may be provided in a different format of database. The name of attack abnormality relationship table may be set appropriately. For example, the attack abnormality relationship table may be referred to as a pattern matching table (PMT) or an abnormality detection pattern.

It is possible to create or generate the patterns of abnormality occurrence in the attack abnormality relationship table by simulating which security sensor in which ECUs 20 will detect an abnormality in what order in the event of an attack, based on the arrangement of ECUs 20 that configure the electronic control system S, the connection relationship of the ECUs 20 (also referred to as network topology), and the arrangement of security sensors installed in the ECUs 20. The patterns of abnormality occurrence may be created or generated based on information related to a monitoring target of security sensor and the rules for monitoring the target.

The creation or generation of the attack abnormality relationship table is not limited to this method. For example, AI or machine learning may be used to generate the attack abnormality relationship table. Alternatively, the patterns of abnormality occurrence may be created or generated using history data related to pattern of abnormality occurrence caused by attacks received in past.

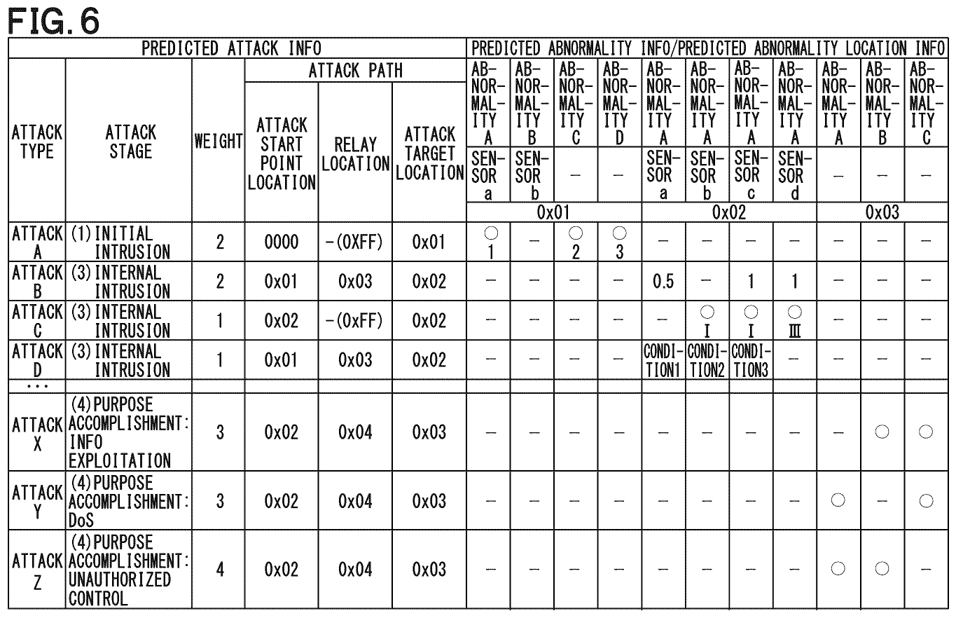

FIG. 6 is another example of the attack abnormality relationship table. The attack abnormality relationship table in FIG. 5 shows only the patterns of abnormalities that occur when an attack occurs and the locations at which the abnormalities occur. The attack abnormality relationship table may include further information or conditions.

For example, information about the occurrence order of the abnormalities in the attack A may be included in the attack abnormality relationship table. In FIG. 6, the Arabic numerals below the circles indicate the occurrence order of the abnormalities, and the occurrence order of the abnormalities is abnormality A, then abnormality C, and then abnormality D.

For example, information on the possibility (reliability) or probability of abnormality occurrence in the attack B may be included in the attack abnormality relationship table. In FIG. 6, the numbers corresponding to attack B indicate the probability of abnormality occurrence, and the occurrence probability of abnormality A in sensor a is 50%, the occurrence probability of abnormality A in sensors c and d is 100%.

For example, information on the number of occurrence times of abnormality in the attack C is included in the attack abnormality relationship table In FIG. 6, the Roman numerals below the circles indicate the number of occurrence times of abnormality, and the occurrence times of abnormality A in sensor b is once, the occurrence times of abnormality A in sensor c is once, and the occurrence times of abnormality A in sensor d is three times.

For example, information about a condition under which an abnormality occurs in the attack D may be included in the attack abnormality relationship table. FIG. 6 shows that the abnormality A that satisfies the condition 1 occurs in the sensor a, the abnormality A that satisfies the condition 2 occurs in the sensor b, and the abnormality A that satisfies the condition 3 occurs in the sensor c.

The additional information of attack abnormality relationship describe above may be properly combined with one another.

The attack estimation unit 103 estimates the attack received by the electronic control system S based on the security log acquired by the log acquisition unit 101 and the attack abnormality relationship table stored in the attack abnormality relationship information storage 102.

For example, in FIG. 5, when three security logs are obtained as follows: security log 1: ECU ID=0x01, sensor ID=a, event ID=abnormality A; security log 2: ECU ID=0x01, sensor ID=null, event ID=abnormality C; and security log 3: ECU ID=0x01, sensor ID=null, event ID=abnormality D, it is estimated that attack A has occurred.

When there is no perfectly matching pattern in the attack abnormality relationship table, the closest pattern may be selected and a matching degree indicating the degree of matching may be calculated. The degree of matching refers to the identical degree between an abnormality indicated by a security log and an abnormality indicated by the predicted abnormality information. For example, in FIG. 5, when two security logs are obtained as follows: security log 1: ECU ID=0x02, sensor ID=a, event ID=abnormality A, and security log 2: ECU ID=0x02, sensor ID=b, event ID=abnormality A, the matching degree of attack B is 1/3, the matching degree of attack C is 1/3, and the matching degree of attack D is 2/3. Thus, attack D is the closest pattern to the occurred attack. Therefore, in this case, it is estimated that attack D is occurred, and 2/3 is output as the matching degree.

The attack estimation accuracy analysis unit 104 analyzes the estimation accuracy of the attack estimated by the attack estimation unit 103 based on the context data included in the security log acquired by the log acquisition unit 101. Specific context data to be used and a method for analyzing the accuracy of attack estimation will be described in each embodiment below.

Here, the term “based on” includes a case where the context data is used directly and a case where the context data is used indirectly. That is, the term “based on” includes a case where intermediate facts are inferred (or estimated) from context data and the accuracy of the attack estimation is analyzed using the inferred (or estimated) intermediate facts.

The context data related information storage 105 stores context data related information. The context data related information is information used by the reference attack factor information estimation unit 106 (to be described later) to estimate reference attack factor information, which is attack factor information related to the context data, based on the context data. Examples of the context data related information include a table that links context data with reference attack factor information, and a mathematical formula that uses context data as an input value.

Specific examples of the context data related information will be described in each of the following embodiments.

The reference attack factor information estimation unit 106 estimates reference attack factor information, which is attack factor information related to the context data, using the context data related information stored in the context data related information storage 105 based on the context data of the security log acquired by the log acquisition unit 101. The reference attack factor information is, for example, information corresponding to factor information included in the predicted attack information.

The context data and context data related information specifically used in the reference attack factor information estimation unit 106 will be described in each embodiment below.

When the reference attack factor information estimation unit 106 is provided, the attack estimation accuracy analysis unit 104 analyzes the estimation accuracy of the attack estimated by the attack estimation unit 103 based on the reference attack factor information estimated by the reference attack factor information estimation unit 106.

The context data related information storage 105 and the reference attack factor information estimation unit 106 may be properly omitted in the present embodiment. When the attack estimation accuracy analysis unit 104 directly uses the context data of security log to analyze the attack estimation accuracy, the context data related information storage 105 and the reference attack factor information estimation unit 106 are not necessary.

The output unit 107 outputs attack information indicating the attack estimated by the attack estimation unit 103 and estimation accuracy information indicating the estimation accuracy of the attack. The estimation accuracy information is analyzed by the attack estimation accuracy analysis unit 104. The attack information may be all or a part of the predicted attack information included in the attack abnormality relationship table. The attack information may be output together with the matching degree and other related information.

The Attack information may be any information related to an attack, such as the type or category of attack, the attack path such as the start point of the attack or the target of the attack, or the damage caused by the attack.

The estimation accuracy information may directly or indirectly indicate the estimation accuracy, and may be expressed in any manner, such as numerical values, symbols, words, sentences, etc.

### (2) Specific Example of Analysis Executed by Attack Estimation Accuracy Analysis Unit 104

### (a) Example 1: Analysis Using Consistency Between Communication Direction Information and Attack Path

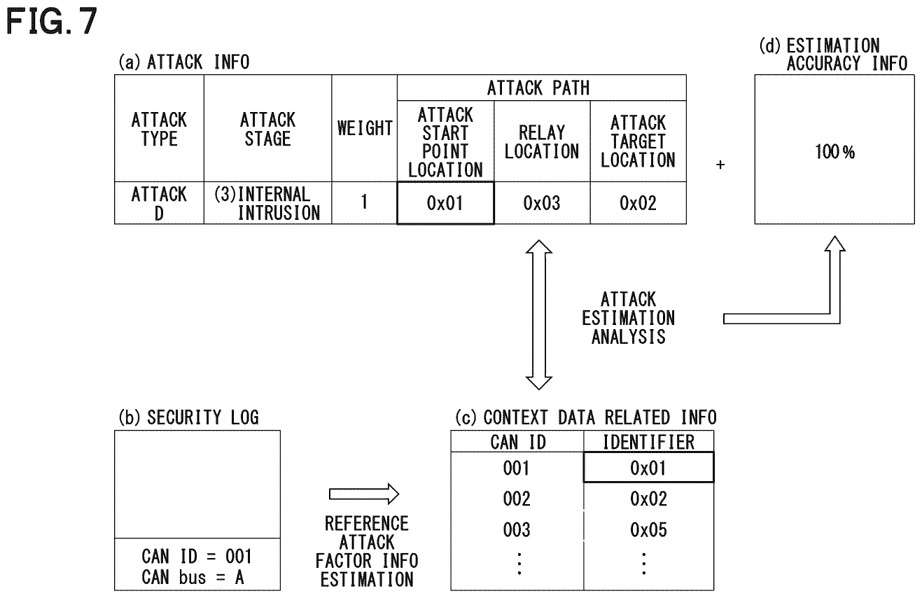

The context data may include information about the source and destination of a frame in which an abnormality is detected. The attack information obtained as a result of attack estimation may include an attack path including the start point of the attack and the target of the attack. Such information enables to grasp a flow from the source of attack to the target of attack. When such information is consistent to one another and does not contradict, the accuracy of attack estimation can be determined to be high. The present embodiment is an example of analyzing the accuracy of attack estimation by utilizing this feature. The following will describe an example with reference to FIG. 7.

In the present embodiment, it is estimated that the attack information output as a result of the attack estimation includes an attack path, which includes the start point of attack and the target of attack. For example, when the attack D is estimated using the attack abnormality relationship table shown in FIG. 5, the attack information includes, as the attack factor information, the attack type is attack D, the attack stage is internal intrusion, the weight is 1, and the attack path as the attack start point location is 0x01, the relay location is 0x03, and the attack target location is 0x02, as shown in (a) of FIG. 7.

In the present embodiment, suppose that the context data includes communication direction information based on which the source and/or destination can be estimated. For example, as shown in (b) of FIG. 7, suppose that CAN ID=001 and CAN bus=A are included in the context data of the security log output by the CAN network-based intrusion detection system (NIDS).

The CAN ID is identification information that indicates the type of CAN frame in which an abnormality is occurred. Thus, when the CAN ID is specified, the ECU that transmitted the CAN frame can be identified. In the present embodiment, as shown in (c) of FIG. 7, a table describing the correspondence between the CAN ID and the identifier of ECU that transmits the CAN ID is stored in the context data related information storage 105 as context data related information. The reference attack factor information estimation unit 106 uses this table to estimate the identifier 0x01, which corresponds to the reference attack factor information, based on the context data of CAN ID=001.

The attack estimation accuracy analysis unit 104 analyzes the estimation accuracy of the attack information as shown in (a) of FIG. 7 based on the identifier 0x01, which corresponds to the reference attack factor information. Specifically, the attack estimation accuracy analysis unit 104 determines whether the attack path includes reference attack factor information. In the present embodiment, since the identifier 0x01 is included as the start point of attack path of attack information as shown in (a) of FIG. 7, it is determined that there are no contradictions and the contents of attack information consistent to the context data, and the accuracy of attack estimation is analyzed to be 100% match.

Based on the above-described example, the output unit 107 outputs the attack information shown in (a) of FIG. 7 together with the estimation accuracy information of matching degree 100% as shown in (d) of FIG. 7.

In the above-described example, one security log is used to analyze the estimation accuracy of attack. Alternatively, multiple security logs may be used to analyze the estimation accuracy of attack. For example, when three security logs are used to estimate an attack, reference attack factor information can be estimated for the context data of each security log, and the matching degree can be calculated by determining whether each reference attack factor information is included in the attack path. For example, when, in each of two security logs, the attack information and the context data are consistent with one another, the matching degree may be analyzed as 67%.

In the present embodiment, the CAN ID is used as the context data as an example. Alternatively, communication direction information other than CAN ID may be used as the context data. For example, an IP address or a MAC address may be used as the context data. Other header information, such as a source message ID for MAC authentication, Firewall/TLS verification, Ethernet-NIDS, etc. may also be used.

According to the present embodiment, communication direction information that can estimate the source and/or destination is used as context data to analyze the consistency with the attack path. Thus, a party who use the result of attack estimation can use different attack information depending on the estimation accuracy. For example, attack information with high estimation accuracy can be used with a higher priority.

### (b) Example 2: Analysis Using Consistency Between Communication Direction Information and Attack Stage

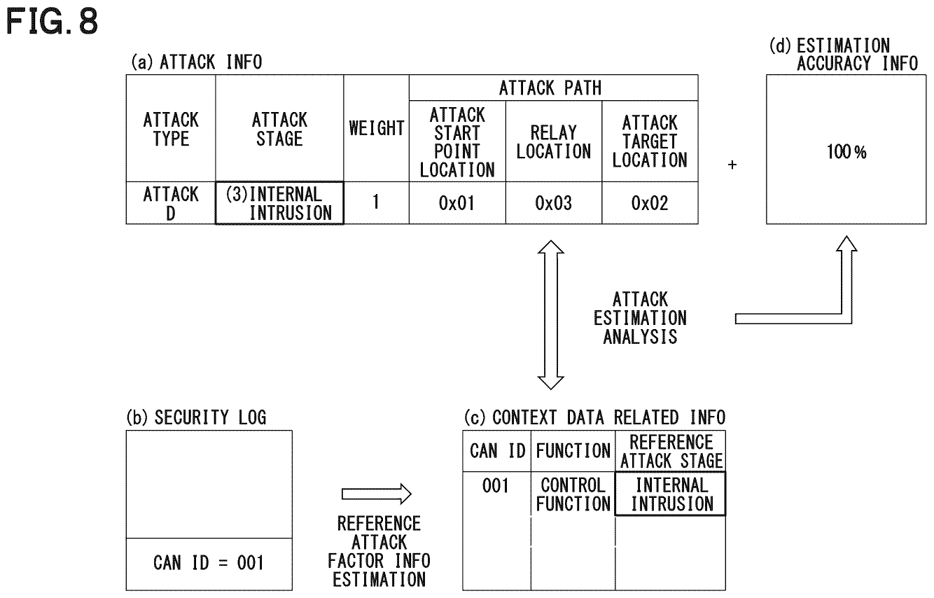

The context data may include information about the source and destination of a frame in which an abnormality is detected. Source and destination information is closely related to the attack stage. The attack information obtained as a result of attack estimation may include the attack stage. When the reference attack stage estimated based on the context data matches the attack stage obtained as a result of attack estimation, it can be said that the attack estimation accuracy is high. The present embodiment is an example of analyzing the accuracy of attack estimation by utilizing this feature. The following will describe an example with reference to FIG. 8.

In the present embodiment, suppose that the attack information output as a result of the attack estimation includes the attack stage. For example, when the attack D is estimated using the attack abnormality relationship table shown in FIG. 5, the attack information includes, as the attack factor information, the attack type is attack D, the attack stage is internal intrusion, the weight is 1, and the attack path as the attack start point location is 0x01, the relay location is 0x03, and the attack target location is 0x02, as shown in (a) of FIG. 8.

In the present embodiment, suppose that the context data includes communication direction information based on which the source and/or destination can be estimated. For example, as shown in (b) of FIG. 8, suppose that CAN ID=001 is included in the context data of the security log output by the CAN NIDS.

The CAN ID is identification information that indicates the type of CAN frame in which an abnormality is occurred. Thus, when the CAN ID is specified, the ECU that uses the CAN frame can be identified. When the function of ECU is known, possible attack stage can be narrowed down based on the function of ECU and the location of ECU within the network. In the present embodiment, a table shown in (c) of FIG. 8 is stored in the context data related information storage 105 as context data related information. The table describes a correspondence among a CAN ID, a function of ECU that uses the CAN frame corresponding to the CAN ID, and an attack stage (corresponding to a “reference attack stage”) that may be related to the ECU having that function using this table, the reference attack factor information estimation unit 106 estimates that the reference attack stage is an internal intrusion based on the context data of CAN ID=001.

The attack estimation accuracy analysis unit 104 analyzes the estimation accuracy of the attack information as shown in (a) of FIG. 8 based on the reference attack stage, which corresponds to the reference attack factor information. Specifically, the attack estimation accuracy analysis unit 104 determines whether the attack stage matches the reference attack stage. In the present embodiment, since the attack stage in (a) of FIG. 8 matches the reference attack stage shown in (c) of FIG. 8, that is, both indicate the internal intrusion, it is determined that the content of attack stage is consistent with one another without contradiction. Thus, the estimated attack accuracy is analyzed to have matching degree of 100%.

Based on the above-described example, the output unit 107 outputs the attack information shown in (a) of FIG. 8 together with the estimation accuracy information of matching degree 100% as shown in (d) of FIG. 8.

In the above-described example, one security log is used to analyze the estimation accuracy of attack. Alternatively, multiple security logs may be used to analyze the estimation accuracy of attack.

In the present embodiment, the CAN ID is used as the context data as an example. Alternatively, communication direction information other than CAN ID may be used as the context data. For example, an IP address or a MAC address may be used as the context data. Other header information, such as a source message ID for MAC authentication, Firewall/TLS verification, Ethernet-NIDS, etc. may also be used.

In the above example, when the attack stage is included in the attack estimation result, the accuracy of attack estimation is estimated using the communication direction information of context data. The context data used to estimate the accuracy of attack estimation including an attack stage is not limited to the communication direction information.

For example, the accuracy of attack estimation including an attack stage may be estimated using an identifier indicating software or a process in which an abnormality, such as an error is occurred, among the above-described various data of context data. This is based on an assumption that a particular attack stage may be closely related to an abnormality occurred in, among various software and processes in the vehicle, particular software or a particular process of a particular function. For example, it is considered that the attack stage of unauthorized vehicle control may be closely related to an error in the software related to the vehicle control function of the control ECU.

When the attack estimation accuracy analysis unit 104 obtains the result of attack estimation including the attack stage, the attack estimation accuracy analysis unit 104 may determine whether the context data indicates an abnormality in software or a process that is related to a specific function. Herein, the specific function is a function determined in advance as being related to a specific attack stage. This determination may be performed by comparing (i) the software or processes in which the occurrence of the abnormality is indicated in the context data with (ii) the software or processes related to the specific function that has been determined in advance as being related to the specific attack stage. When the context data indicates an abnormality in the software or process of the specific function, the attack estimation accuracy analysis unit 104 estimates that the accuracy of the attack estimation is high. When the context data does not indicate an abnormality in the software or process of the specific function, the attack estimation accuracy analysis unit 104 does not estimate that the accuracy of the attack estimation is high. For such an estimation, a list may be prepared in advance as context data related information in which an identifier indicating a software or a process of specific function in a specific ECU is linked to the attack stage.

As communication direction information, the context data may indicate the execution of specific software or specific process. For example, a CAN ID as communication direction information may indicate the execution of specific software or specific process that performs or utilizes communication of the corresponding CAN ID. In this case, the reference attack factor information estimation unit 106 can estimate the reference attack stage by using, as the context data related information, the execution of specific software or specific process, the function of specific software or specific process, and the attack stage related to the specific software or specific process having that function.

According to a first aspect of the present embodiment, the reference attack stage is estimated using communication direction information based on which the source and/or destination can be estimated as context data. Then, the consistency of estimated reference attack stage with the attack stage obtained as a result of attack estimation is analyzed. Thus, a party who use the attack estimation result can use different attack information depending on the estimation accuracy.

According to a second aspect of the present embodiment, the context data is indicative of the software or process within the electronic control system in which the abnormality is occurred. When the attack estimation accuracy analysis unit 104 acquires the attack information, which includes the attack stage obtained by estimating the attack, the attack estimation accuracy analysis unit analyzes the estimation accuracy of attack based on whether the context data indicates an abnormality in the software or process, which has the specific function. Herein, the specific function determined in advance as being related to the attack stage. Therefore, the party who uses the attack estimation result can use different attack information depending on the estimation accuracy.

### (c) Example 3: Analysis Using Consistency Between Communication Volume or Error Type and Attack Stage

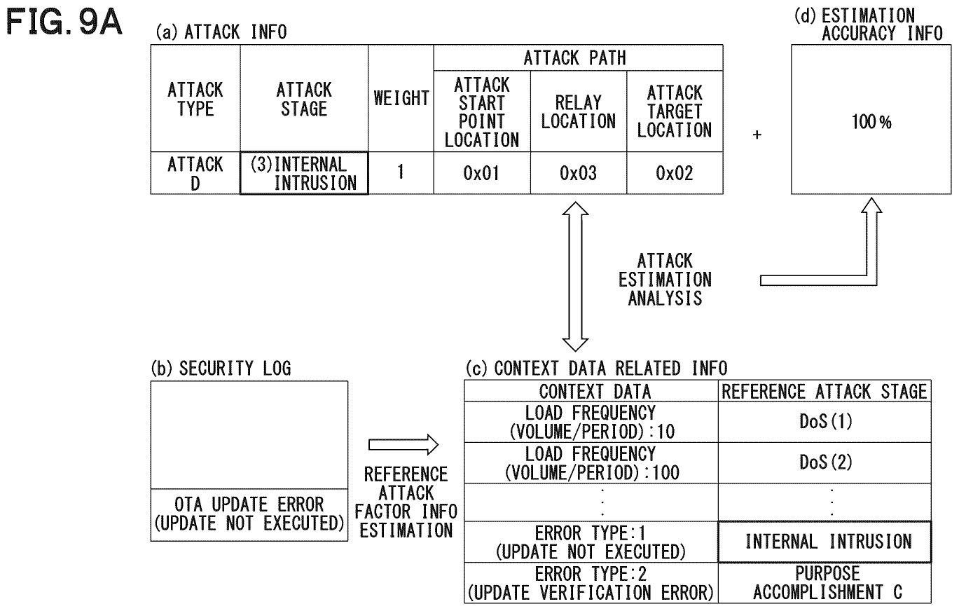

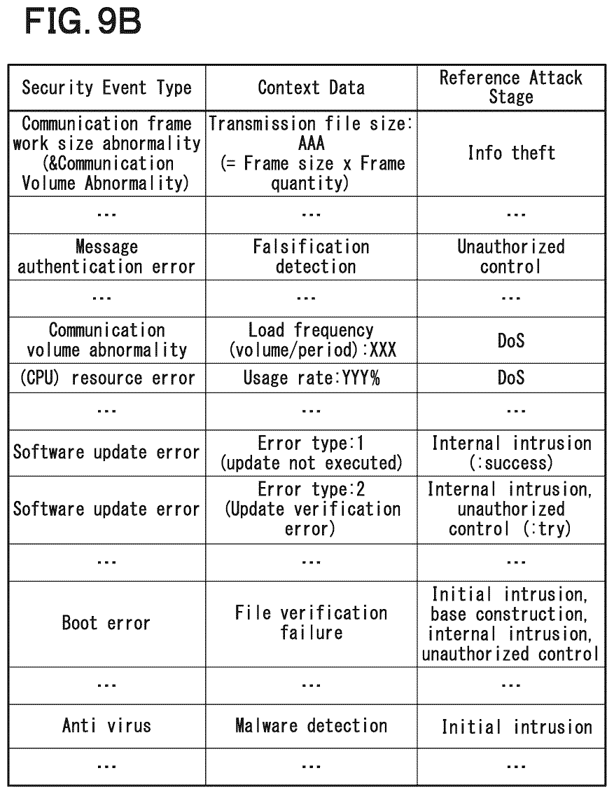

The context data may include an abnormality related to communication volume and various error types. These kinds of information may indicate an abnormality detected during a cyberattack. In this case, the information is closely related to the attack stage. The attack information obtained as a result of attack estimation may include the attack stage. When the reference attack stage estimated based on the context data matches the attack stage obtained as a result of attack estimation, it can be said that the attack estimation accuracy is high. The present embodiment is an example of analyzing the accuracy of attack estimation by utilizing this feature. The following will describe an example with reference to FIG. 9A.

In the present embodiment, the attack information output as a result of the attack estimation includes the attack stage. For example, when the attack D is estimated using the attack abnormality relationship table shown in FIG. 5, the attack information includes: attack factor information indicating that the attack type is attack D; attack factor information indicating that the attack stage is internal intrusion; attack factor information indicating that the weight is 1; and attack factor information indicating such the attack path that the attack start point location is 0x01, the relay location is 0x03, and the attack target location is 0x02, as shown in (a) of FIG. 9A.

In the present embodiment, the context data includes information on the communication volume and the error type. For example, as shown in (b) of FIG. 9A, suppose that an OTA update error (update not executed) is stored in security log.

Since the OTA update error indicates at which stage of the update the error occurred, the attack stage can be estimated based on the OTA update error. Additionally, the abnormality related to communication volume is particularly closely related to a DOS attack. Therefore, in the present embodiment, the context data related information storage 105 stores, as the context data related information, a table describing the correspondence between the context data and an attack stage to which the context data may be related as shown in (c) of FIG. 9A. The attack stage to which the context data may be related corresponds to a reference attack stage. Using this table, the reference attack factor information estimation unit 106 estimates that the reference attack stage is the internal intrusion based on the OTA update error (update not executed).

The attack estimation accuracy analysis unit 104 analyzes the estimation accuracy of attack information shown in (a) of FIG. 9A based on the reference attack stage, which corresponds to the reference attack factor information. Specifically, the attack estimation accuracy analysis unit 104 determines whether the attack stage matches the reference attack stage. In the present embodiment, since the attack stage in (a) of FIG. 9A matches the reference attack stage shown in (c) of FIG. 9A, that is, both indicate the internal intrusion, it is determined that the content of attack stage is consistent with one another without contradiction. Thus, the estimated attack accuracy is analyzed to have matching degree of 100%.

Based on the above-described example, the output unit 107 outputs the attack information shown in (a) of FIG. 9A together with the estimation accuracy information of matching degree 100% as shown in (d) of FIG. 9A.

According to the present embodiment, the reference attack stage is estimated using abnormality related to communication volume or various error types. Then, the consistency between estimated reference attack stage and the attack stage obtained as a result of attack estimation is analyzed. Thus, a party who use the attack estimation result can use different attack information depending on the estimation accuracy.

In the present embodiment, it is determined whether the reference attack stage estimated from the context data matches the attack stage obtained as a result of attack estimation. Alternatively, as a variation of the present embodiment, it may be determined whether the reference attack stage estimated from a combination of security event type and context data matches the attack stage obtained as a result of attack estimation.

The security event type can be identified from the event ID stored in the event ID field of security log shown in FIG. 3.

Then, as the context data related information shown in (c) of FIG. 9A, a table shown in FIG. 9B is used as a table that describes the relationship between (i) the combination of security event type and context data and (ii) the attack stage that may be related to the combination. The attack stage that may be related to the combination corresponds to the reference attack stage.

According to this modified example, the reference attack stage is estimated based on the combination of security event type and context data, and the estimation accuracy of attack information is analyzed based on the estimated reference attack stage. Thus, estimation accuracy can be improved.

### (d) Example 4: Analysis Using Consistency of Sensor Firing Order

The context data may include time information related to generation time of the security log or transmission time of the security log. The time information can be used to estimate the detection order of abnormalities occurred due to a cyberattack.

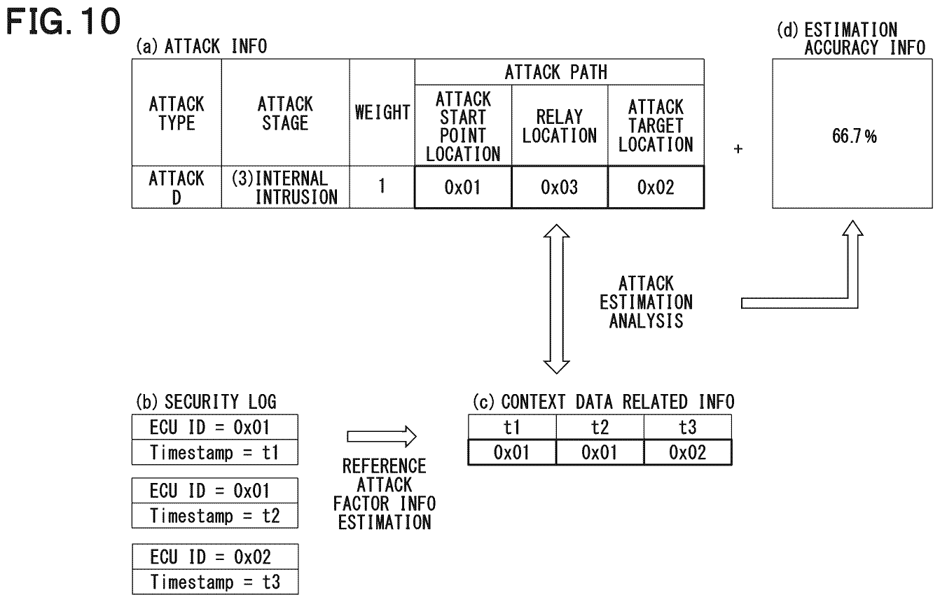

The attack information obtained as a result of attack estimation may include an attack path, which includes the start point of attack and the target of attack. The attack path may include abnormality occurrence order, which is information related to temporal progression. When the time information estimated from the context data matches the abnormality occurrence order estimated from the attack path, which is obtained as a result of attack estimation, it can be said that the accuracy of the attack estimation is high. The present embodiment is an example of analyzing the accuracy of attack estimation by utilizing this feature. The following will describe an example with reference to FIG. 10.

In the present embodiment, the attack information output as a result of attack estimation includes an attack path, which includes the start point of attack and the attack target. For example, when the attack D is estimated using the attack abnormality relationship table shown in FIG. 5, the attack information includes: the attack factor information indicating that the attack type is attack D; the attack factor information indicating that the attack stage is internal intrusion; the attack factor information indicating that the weight is 1; and the attack factor information indicating the attack path such that the attack start point location is 0x01, the relay location is 0x03, and the attack target location is 0x02, as shown in (a) of FIG. 10.

In the present embodiment, the time stamp of security log shown in FIG. 3 includes time information related to the generation time of security log or the transmission time of security log. For example, as shown in (b) of FIG. 10, suppose that timestamps t1, t2, and t3 (t1<t2<t3) are stored in three security logs, respectively.

Further, suppose that the ECU IDs of the three security logs are set to 0x01, 0x01, and 0x02, respectively.

Here, time information may be any information that can be used to estimate the generation time of security log or the transmission time of security log. For example, the time information may include a time stamp, the execution time of process, a counter, a travel distance, and the number of starts.

Since the information about the ECU in which the abnormality is occurred is correlated to the occurrence time of the abnormality in each security log, it is possible to rearrange these security logs chronologically to estimate the reference abnormality occurrence order, which is the order in which the abnormalities indicated by the security logs occurred. Therefore, as shown in (c) of FIG. 10, the reference attack factor information estimation unit 106 of the present embodiment can estimate the reference abnormality occurrence order, which indicates which abnormality occurred in which ECU in what order, by matching the time information with the ECU in which the abnormality occurred and rearranging the time information in the abnormality occurrence order. In the case shown in (c) of FIG. 10, the reference abnormality occurrence order is 0x01, 0x01, 0x02.

The attack estimation accuracy analysis unit 104 analyzes the estimation accuracy of the attack information as shown in (a) of FIG. 10 based on the reference abnormality occurrence order, which corresponds to the reference attack factor information. Specifically, the attack estimation accuracy analysis unit 104 compares the abnormality occurrence order estimated from the attack path with the abnormality occurrence order estimated from the time information. In the present embodiment, the attack path in (a) of FIG. 10 is compared with the reference abnormality occurrence order shown in (c) of FIG. 10. In FIG. 10, no abnormality is detected at the relay location, but the ECU in which abnormalities occurred at the attack start point location and the attack target location is consistent with the abnormality occurrence order. Thus, the accuracy of attack estimation is analyzed to be 66.7%.

Thus, the output unit 107 outputs the attack information shown in (a) of FIG. 10 together with the estimation accuracy information shown in (d) of FIG. 10, that is, the matching degree of 66.7%.

In the present embodiment, the time stamp of security log is used as the time information. Alternatively, different time-related information can be used as the time information. For example, data that enables estimation of time or order, such as the processing time of monitoring object stored in the context data, a counter value, a travel distance, or the number of times the vehicle has been started, can be used as the time information.

According to the present embodiment, time information is used as the context data and the consistency of time information with the attack path obtained as a result of attack estimation is analyzed. Thus, a party who use the result of attack estimation can use different attack information depending on the estimation accuracy.

In the present embodiment, it is determined whether the abnormality occurrence order estimated from the attack path matches the abnormality occurrence order estimated from the context data. Alternatively, when information on the abnormality occurrence order is provided, such as the attack A in the attack abnormality relationship table shown in FIG. 6, it may be determined whether the abnormality occurrence order in the attack abnormality relationship table matches the abnormality occurrence order estimated from the context data.

For example, in a case where a first security sensor monitors the input function of an ECU and a second security sensor monitors the internal function of this ECU, considering an intrusion path of cyberattack, it is predicted that the first security sensor detects an abnormality earlier than the second security sensor. Therefore, information on the abnormality occurrence order may be provided as is the case of the attack A shown in the attack abnormality relationship table.

The attack estimation accuracy analysis unit 104 may compare the abnormality occurrence order in the attack abnormality relationship table with the reference abnormality occurrence order estimated from the time information.

### (e) Example 5: Analysis Using Blacklist/Whitelist

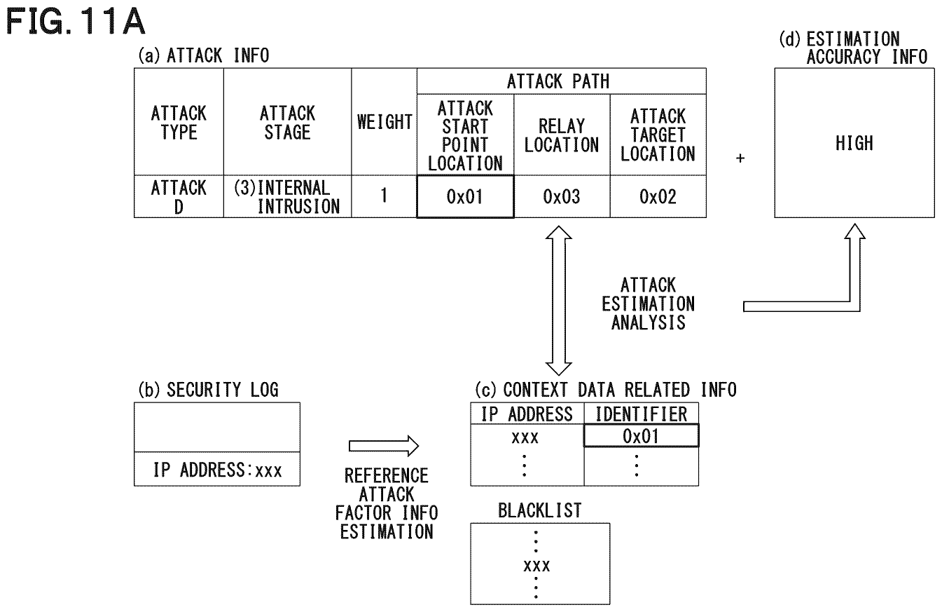

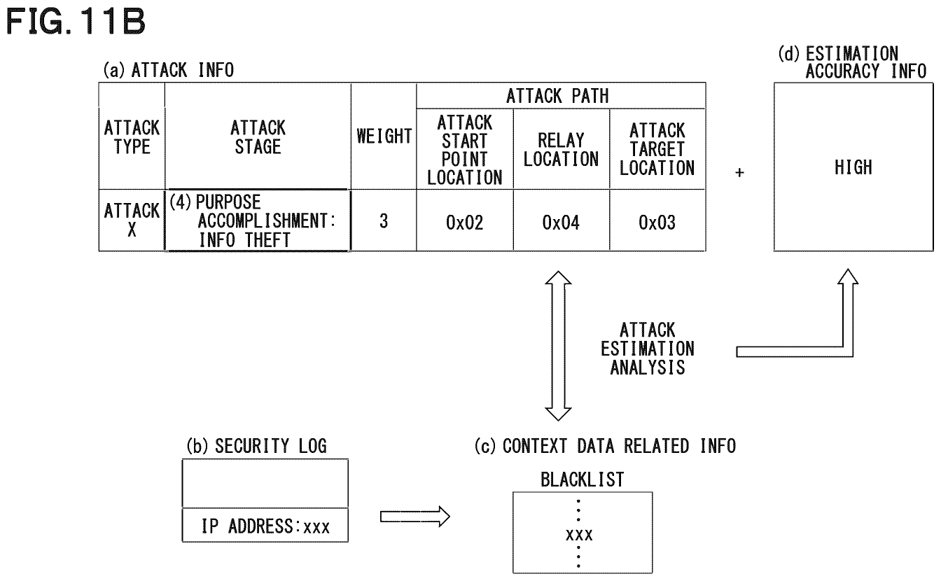

The context data may include information about a transmission source of the frame in which the abnormality is detected. When the transmission source is included in a blacklist or not included in a whitelist, there is a high possibility that the transmission source is used in the cyberattack. When the attack information obtained as a result of attack estimation includes this transmission source, it can be said that the attack information has a high estimation accuracy. The present embodiment is an example of analyzing the accuracy of attack estimation by utilizing this feature. The following will describe an example with reference to FIG. 11A.

In the present embodiment, the attack information output as a result of attack estimation includes an attack path, which includes the start point of attack and the attack target. For example, when the attack D is estimated using the attack abnormality relationship table shown in FIG. 5, the attack information includes such the attack factor information that: the attack type is attack D; the attack stage is internal intrusion; the weight is 1; and the attack path has the attack start point location of 0x01, the relay location of 0x03, and the attack target location of 0x02, as shown in (a) of FIG. 11A.

In the present embodiment, the context data includes communication direction information based on which the source and/or destination can be estimated. For example, as shown in (b) of FIG. 11A, suppose that IP address=xxx is stored in the context data of the security log.

The IP address is identification information that indicates the address of a device in which an abnormality is occurred. The device may be an ECU, and the ECU in which an abnormality is occurred can be identified by using the IP address. In the present embodiment, the context data related information storage 105 stores a table describing the correspondence between IP addresses and ECU identifiers as shown in (c) of FIG. 11A, as the context data related information. By using this table, the reference attack factor information estimation unit 106 estimate the identifier 0x01, which is the reference attack factor information, from the IP address=xxx corresponding to the context data.

As shown in (c) of FIG. 11A, the context data related information storage 105 further stores a blacklist, which is information that lists risky transmission sources. The blacklist may be downloaded from a server device that periodically supplies the blacklist and stored in the context data related information storage.

The attack estimation accuracy analysis unit 104 analyzes the estimation accuracy of the attack information as shown in (a) of FIG. 11A based on the identifier 0x01, which corresponds to the reference attack factor information. Specifically, the attack estimation accuracy analysis unit 104 determines whether the attack path includes reference attack factor information. When the attack path includes the reference attack factor information, the attack estimation accuracy analysis unit 104 further determines whether the transmission source information is included in a blacklist or determines whether the transmission source information is included in a whitelist. In the present embodiment, as shown in (a) of FIG. 11A, since the attack path, specifically the attack start point includes the identifier 0x01, the attack estimation accuracy analysis unit determines whether a device with an IP address of xxx corresponding to the identifier 0x01, which corresponds to the reference attack factor information, is included in the blacklist. In FIG. 11A, since the device is included in the blacklist, the accuracy of the attack estimation is analyzed to be high.

As described above, the output unit 107 outputs, in addition to the attack information shown in (a) of FIG. 11A, information indicating that the estimation accuracy of the attack is high as estimation accuracy information as shown in (d) of FIG. 11A.

In the above example, a blacklist is described as an example. Alternatively, a whitelist may be used. When using a whitelist, the attack estimation accuracy analysis unit 104 may analyze that the attack estimation accuracy is high if the attack is not included in the whitelist.

The transmission source devices listed on the blacklist or whitelist may be devices installed outside the vehicle. The vehicle corresponds to the moving object. Examples of such devices include servers at OEM centers and devices brought into vehicles.

In the present embodiment, a case where the transmission source is included in the blacklist or not included in the whitelist is described. The present disclosure may also be applied to a case where the transmission destination or relay location is included in the blacklist or not included in the whitelist. That is, the communication direction information may be included in the attack start point location or relay location of the attack path.

The attack abnormality relationship table in FIG. 5 used in the present embodiment assumes an attack path starting from the outside to the inside of electronic control system S. The attack abnormality relationship table may also be used for an attack path starting from the inside to the outside of electronic control system S. In this case, the attack path is estimated after the attack objective is partially achieved. For example, when the attack stage is purpose accomplishment (theft of information), the attack path may be the path for transmitting the exploited information to an external device.

According to the present embodiment, transmission source information that enables estimation of transmission source is used as the context data, and consistency with the attack path is analyzed. The accuracy of attack estimation is analyzed by determining whether the transmission source is included in the blacklist. Therefore, a party who uses the attack estimation result can use different attack information depending on the estimation accuracy.

In the present embodiment, the estimation accuracy of attack information is analyzed by comparing the reference attack factor information obtained from the context data with the attack path. Alternatively, the estimation accuracy of attack information may be analyzed by a method other than direct comparison. The following will describe a modification of the present embodiment.

In a modified example, when an attack X is estimated using the attack abnormality relationship table of FIG. 5, the attack information includes, as shown in (a) of FIG. 11B, attack factor information. The attack factor information includes attack type of attack X, attack stage of purpose accomplishment (information theft), weight of 3, attack path including attack start point location of 0x02, relay location of 0x04, and attack target location of 0x03.

In this modification, suppose that the IP address=xxx is stored in the context data shown in (b) of FIG. 11B.

The attack estimation accuracy analysis unit 104 analyzes that the attack estimation accuracy is high when the attack stage shown in (a) of FIG. 11B is purpose accomplishment (information theft) and the IP address indicated in the context data is included in the blacklist. This is because the estimation result of attack is consistent when it is assumed that the IP address indicated in the context data is a device related to the reason or result of the purpose accomplishment. For example, it is possible that the IP address indicates a known malicious site, and the security log including the IP address is generated as a result of transmitting stolen information to an attacker.

### (f) Example 6: Analysis Using Consistency Between Communication Direction Information and Attack Path

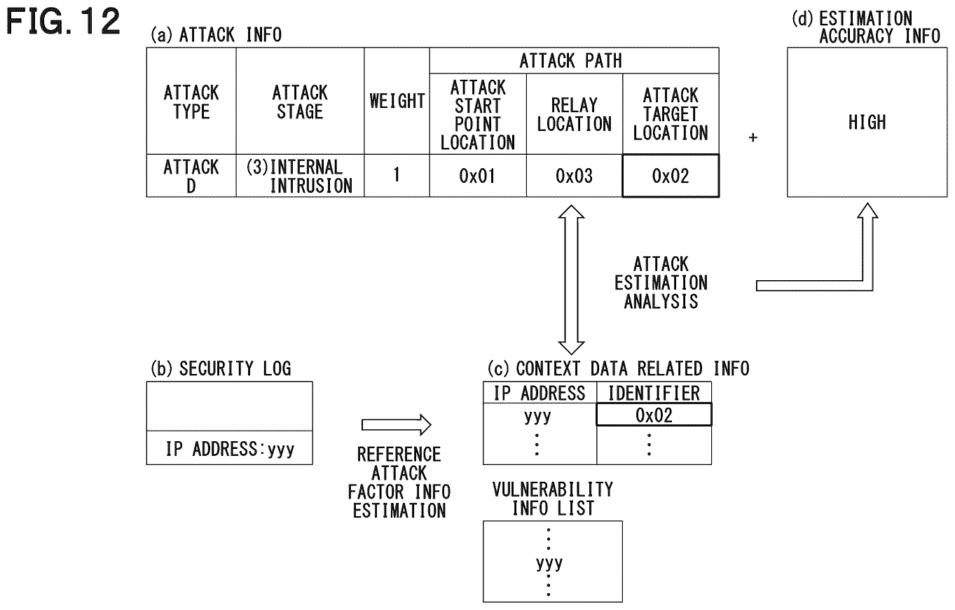

The context data may include information about the transmission destination of frame in which an abnormality is detected. When a vulnerability of the transmission destination is at issue, there is a high possibility that the transmission destination is subject to a cyberattack. The attack information obtained as a result of attack estimation and including the transmission destination can be said to have a high estimation accuracy. The present embodiment is an example of analyzing the accuracy of attack estimation by utilizing this feature. The following will describe an example with reference to FIG. 12.

In the present embodiment, suppose that the attack information output as a result of attack estimation includes an attack path, which includes the start point of attack and the attack target. For example, when the attack D is estimated using the attack abnormality relationship table shown in FIG. 5, the attack information includes, as the attack factor information, the attack type is attack D, the attack stage is internal intrusion, the weight is 1, and the attack path as the attack start point location is 0x01, the relay location is 0x03, and the attack target location is 0x02, as shown in (a) of FIG. 12.

In the present embodiment, the context data includes communication direction information based on which the source and/or destination can be estimated. For example, as shown in (b) of FIG. 12, suppose that IP address=yyy is stored in the context data of the security log.

The IP address is identification information that indicates the address of a device in which an abnormality is occurred. The device may be an ECU, and the ECU in which an abnormality is occurred can be identified by using the IP address. In the present embodiment, the context data related information storage 105 stores a table describing the correspondence between IP addresses and ECU identifiers as shown in (c) of FIG. 12, as the context data related information. By using this table, the reference attack factor information estimation unit 106 estimate the identifier 0x02, which is the reference attack factor information, from the IP address=yyy corresponding to the context data.

The context data related information storage 105 stores a vulnerability information list, which is information that lists devices vulnerable to cyberattacks, as shown in (c) of FIG. 12. The vulnerability information list is downloaded from a server device that periodically provides vulnerability information list, and is stored in local.

The attack estimation accuracy analysis unit 104 analyzes the estimation accuracy of the attack information as shown in (a) of FIG. 12 based on the identifier 0x02, which corresponds to the reference attack factor information. Specifically, the attack estimation accuracy analysis unit 104 determines whether the attack path includes reference attack factor information. When the attack path includes the reference attack factor information, the attack estimation accuracy analysis unit 104 further determines whether the communication direction information is included in the vulnerability information list. In the present embodiment, as shown in (a) of FIG. 12, since the attack path, specifically the attack target location includes the identifier 0x02, the attack estimation accuracy analysis unit determines whether a device with an IP address of yyy corresponding to the identifier 0x02, which corresponds to the reference attack factor information, is included in the vulnerability information list. In FIG. 12, since the device is included in the vulnerability information list, the accuracy of the attack estimation is analyzed to be high.

As described above, the output unit 107 outputs, in addition to the attack information shown in (a) of FIG. 12, information indicating that the estimation accuracy of the attack is high as estimation accuracy information as shown in (d) of FIG. 12.

In the present embodiment, a case where the vulnerability of transmission destination is focused has been described as an example. However, the present disclosure may also be applied to a case where a vulnerability of transmission source or relay location may cause a cyberattack. That is, the communication direction information may be included in the attack start point location or relay location of the attack path.

In the present embodiment, IP address is described as an example of the context data. Alternatively, the context data may be other communication direction information, such as a CAN ID. The context data is not limited to communication direction information. For example, among the various data included in the above-mentioned context data, an identifier indicating the software or process in which an abnormality such as an error has occurred may be used as the context data. Among the software and processes of the vehicle, the vulnerability information list may include information about vulnerable software and processes, and may further include devices such as ECUs on which the vulnerable software and processes are executed. These are based on the assumption that cyberattacks may be closely related to the execution of the vulnerable software or processes in the vehicle, which have vulnerability issues. From this viewpoint, the software or process, in which an abnormality has occurred as indicated in the context data, refers to a software or process, in which the occurrence of abnormality is detected after the software or process is executed.

The attack estimation accuracy analysis unit 104 may use the context data to determine whether vulnerable software or process included in the vulnerability information list was executed in the estimated attack path. This determination can be made by matching the software or process in which the abnormality indicated in the context data occurred with the vulnerability information list. When the attack estimation accuracy analysis unit 104 determines that vulnerable software or process included in the vulnerability information list was executed in the estimated attack path, it is estimated that the accuracy of attack path estimation is high. When it is determined that there was no execution of any vulnerable software nor software included in the vulnerability information list in the estimated attack path, the accuracy of estimated attack path is determined to be low.

As the communication direction information, the context data may be information indicating the execution of specific software or specific process.

The above-mentioned vulnerability list can be generated, for example, by identifying in advance specific software or processes in a vehicle that have been found to have the potential to be exploited in attacks based on known vulnerability information, and listing the ECUs that execute the specific software or processes. For attack path that include an ECU on which specific software or processes are executed, the accuracy of attack estimation is analyzed to be high when the context data indicates that the specific software or process is executed.

Examples of specific software or processes that may be listed in the vulnerability information list include communications using a specific CAN ID when a vulnerability is discovered in communications using that specific CAN ID, or software or a process when a buffer overflow vulnerability is discovered in that software or process. When a vulnerability in a software or process is fixed by a software update or the like, the software or process can be removed from the vulnerability information list.

According to the present embodiment, communication direction information is used as the context data, and consistency with the attack path is analyzed, and the accuracy of attack estimation is analyzed by determining whether the transmission source is included in the vulnerability list. Therefore, a party who uses the attack estimation result can use different attack information depending on the estimation accuracy.

According to a second aspect of the present embodiment, the context data is indicative of the software or process in which the abnormality is occurred. The attack estimation accuracy analysis unit 104 may use the context data to determine whether vulnerable software or process indicated in the vulnerability information list was executed in the estimated attack path, and then analyzes the accuracy of attack estimation. Thus, a party who uses the attack estimation result can use different attack information depending on the estimation accuracy.

### (g) Other Embodiments

The above embodiments suppose that the estimation accuracy information, which is the analysis result analyzed by the attack estimation accuracy analysis unit 104, is output from the output unit 107 together with the attack information. The device that receives the estimation accuracy information uses the estimation accuracy information as one of the indicators for determining how to use the attack information.

The estimation accuracy information may also be used to selection of attack information. For the attack information, which is the estimation result of an attack estimated by the attack analysis device 10, when the estimation accuracy information is below a predetermined matching level, the attack information may be discarded as an incorrect determination. When the estimation accuracy information is equal to or higher than the predetermined matching level, the attack information may be output from the output unit 107.

### (3) Operation of Attack Analysis Device 10

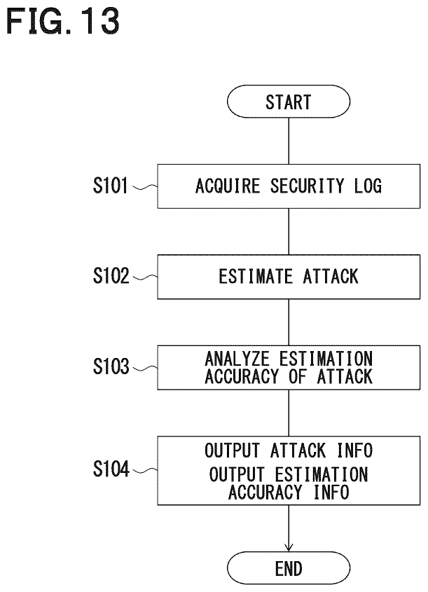

The operation of the attack analysis device 10 will be described with reference to FIG. 13. FIG. 13 not only shows an attack analysis method executed by the attack analysis device 10, but also shows a processing procedure of an attack analysis program executable by the attack analysis device 10. The processing is not limited to an order shown in FIG. 13. The order may be properly changed as long as there is no restriction such as a relationship in which a result of a preceding step is used in a subsequent step.

The attack analysis device 10 has an attack abnormality relationship information storage 102 that stores an attack abnormality relationship table. The attack abnormality relationship table shows the relationship between predicted attack information, which indicates possible attacks on the electronic control system, predicted abnormality information, which indicates abnormalities predicted to occur in response to receiving the attack, and predicted abnormality location information, which indicates the occurrence location of the predicted abnormality within the electronic control system.

In S101, the log acquisition unit 101 of the attack analysis device 10 acquires a security log indicating an abnormality detected in the electronic control system S and the location within the electronic control system S where the abnormality is detected.

In S102, the attack estimation unit 103 estimates the attack on the electronic control system S based on the security log acquired in S101 and the attack abnormality relationship table stored in the attack abnormality relationship information storage 102 (S102).

In S103, the attack estimation accuracy analysis unit 104 analyzes the estimation accuracy of attack estimated in S102 based on the context data included in the security log acquired in S101.

In S104, the output unit 107 outputs attack information indicating the attack estimated in S101 and estimation accuracy information indicating the estimation accuracy of the attack analyzed in S103.

### (4) Short Overview

As described above, according to the attack analysis device 10 of each embodiment, the estimation accuracy of attack is analyzed using the context data included in the security log, and the analysis result is output as estimation accuracy information. Thus, it is possible to use the result of attack estimation based on the accuracy of the estimated result of cyberattack.

Specifically, for example, the priority in usage of attack estimation results can be determined according to the accuracy of attack estimation.

### 3. Summarization

The features of the attack analysis device embodiments are described above.

Since terms used in the embodiments are examples, the terms may be replaced with synonymous terms or terms including synonymous functions.

The block diagrams used for the description of the embodiments are obtained by classifying and organizing the configuration of each device for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the claims are used to distinguish two or more configurations and methods of the same kind and are not intended to limit the order or superiority.

Each of the embodiments described vehicle attack analysis device for analyzing cyberattack on an electronic control system mounted on a vehicle. The present disclosure is not limited to vehicle use. The present disclosure may include a dedicated or general-purpose device other than a vehicle device.

Embodiments of the attack analysis device of the present disclosure may be configured as a component, a semi-finished product, a finished product or the like.

Examples of component include a semiconductor element, an electronic circuit, a module, and a microcomputer.

Examples of semi-finished product include an electric control unit (ECU) and a system board.

Examples of finished product include a cellular phone, a smartphone, a tablet computer, a personal computer (PC), a workstation, and a server.

In addition, the device may include a device having a communication function or the like, and examples the device having a communication function may include a video camera, a still camera, and a car navigation system.

Necessary functions such as an antenna or a communication interface may be properly added to the attack analysis device.

The attack analysis device according to the present disclosure may be used for the purpose of providing various services, especially when used on the server side. Such provision of service may use the attack analysis device according to the present disclosure, the method according to the present disclosure, or/and execution of the program according to the present disclosure.

The device can be implemented not only by dedicated hardware having the configurations and functions described in the embodiments, but also by a combination of a program, which is recorded on a storage medium such as a memory or a hard disk and is used for implementing the above configuration and features, and general-purpose hardware that has a dedicated or general-purpose CPU that can execute the program, a memory, and the like.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. Thereby, the latest functions can be provided at all times through program upgrade.

The attack analysis device of the present disclosure is intended primarily for analyzing attacks on the electronic control systems installed in automobiles, but may also be intended for analyzing attacks on normal systems that are not installed in automobiles.

What is claimed is:

1. An attack analysis device analyzing an attack on an electronic control system mounted on a moving object, the attack analysis device comprising:
a log acquisition unit acquiring a security log indicating an abnormality detected in the electronic control system and a location within the electronic control system where the abnormality is detected;
an attack abnormality relationship information storage storing attack abnormality relationship information indicating a relationship among (i) predicted attack information indicating an attack predicted to be received by the electronic control system, (ii) predicted abnormality information indicating an abnormality predicted to occur when the electronic control system receives the predicted attack, and (iii) predicted abnormality location information indicating a location within the electronic control system where the predicted abnormality occurs;
an attack estimation unit estimating the attack received by the electronic control system based on the security log and the attack abnormality relationship information;
an attack estimation accuracy analysis unit analyzing an estimation accuracy of the attack received by the electronic control system based on context data included in the security log; and
an output unit outputting attack information, which indicates the estimated attack, and estimation accuracy information, which indicates the estimation accuracy of the attack.

2. The attack analysis device according to claim 1, further comprising
a reference attack factor information estimation unit estimating, based on the context data, reference attack factor information that indicates factor information of the attack related to the context data,
wherein the attack estimation accuracy analysis unit analyzes the estimation accuracy of the attack received by the electronic control system based on the reference attack factor information.

3. The attack analysis device according to claim 1, wherein
the attack information includes an attack path, which includes a start point of the attack and a target of the attack,
the context data includes communication direction information that enables estimation of a transmission source or a transmission destination, and
the attack estimation accuracy analysis unit analyzes the estimation accuracy of the attack received by the electronic control system based on whether the communication direction information is included in the attack path.

4. The attack analysis device according to claim 2, wherein
the attack information includes an attack stage indicating an intrusion stage of the attack,
the context data includes communication direction information that enables estimation of a transmission source or a transmission destination,
the reference attack factor information estimation unit estimates, based on the context data, a reference attack stage indicating an intrusion stage of attack related to the communication direction information, as the reference attack factor information, and
the attack estimation accuracy analysis unit analyzes the estimation accuracy of the attack received by the electronic control system based on whether the attack stage included in the attack information is identical to the reference attack stage.

5. The attack analysis device according to claim 1, wherein
the attack information includes an attack stage indicating an intrusion stage of the attack,
the context data indicates a software or process of the electronic control system in which an abnormality is occurred,
the attack stage is related to a predetermined software or process having a specific function, and
when the attack information including the attack stage is acquired, the attack estimation accuracy analysis unit analyzes the estimation accuracy of the attack by determining whether the predetermined software or process is indicated by the context data.

6. The attack analysis device according to claim 2, wherein
the attack information includes an attack stage indicating an intrusion stage of the attack,
the context data includes communication amount or an error type,
the reference attack factor information estimation unit estimates, based on the context data, a reference attack stage indicating an intrusion stage of attack related to the communication amount or the error type, as the reference attack factor information, and
the attack estimation accuracy analysis unit analyzes the estimation accuracy of the attack received by the electronic control system based on whether the attack stage included in the attack information is identical to the reference attack stage.

7. The attack analysis device according to claim 2, wherein
the attack information includes an attack path, which includes a start point of the attack and a target of the attack,
the context data includes time information related to a time when the security log is generated or transmitted,
the reference attack factor information estimation unit estimates, based on the context data, a reference abnormality occurrence order in which abnormalities indicated by the security log are occurred, as the reference attack factor information, and
the attack estimation accuracy analysis unit analyzes the estimation accuracy of the attack by comparing an abnormality occurrence order estimated from the attack path with the reference abnormality occurrence order.

8. The attack analysis device according to claim 1, wherein
the attack information includes an attack path, which includes a start point of the attack and a target of the attack,
the context data includes communication direction information that enables estimation of a transmission source or a transmission destination, and
when the communication direction information is included in the attack path, the attack estimation accuracy analysis unit analyzes the estimation accuracy of the attack received by the electronic control system based on whether the communication direction information is included in a blacklist or a whitelist.

9. The attack analysis device according to claim 1, wherein
the context data indicates a communication partner when the attack detected in the electronic control system is caused by a communication between the electronic control system and an external device,
the attack information includes an attack stage indicating an intrusion stage of the attack, and
when the attack stage is identical to a predetermined attack stage, the attack estimation accuracy analysis unit analyzes the estimation accuracy of the attack based on whether the communication partner is included in a blacklist.

10. The attack analysis device according to claim 1, wherein
the attack information includes an attack path, which includes a start point of the attack and a target of the attack,
the context data includes communication direction information that enables estimation of a transmission source or a transmission destination, and
when the communication direction information is included in the attack path, the attack estimation accuracy analysis unit analyzes the estimation accuracy of the attack received by the electronic control system based on whether the communication direction information is included in a vulnerability information list.

11. The attack analysis device according to claim 1, wherein
the attack information includes an attack path,
the context data indicates a software or process in which the abnormality is occurred, and
the attack estimation accuracy analysis unit analyzes, using the context data, the estimation accuracy of the attack by determining whether a vulnerable software or process indicated in a vulnerability information list is executed in the attack path.

12. The attack analysis device according to claim 1 being located outside the moving object.

13. The attack analysis device according to claim 1 being mounted on the moving object.

14. An attack analysis method executed by an attack analysis device, the attack analysis device analyzing an attack on an electronic control system mounted on a moving object, the attack analysis device including an attack abnormality relationship information storage, which stores attack abnormality relationship information indicating a relationship among (i) predicted attack information indicating an attack predicted to be received by the electronic control system, (ii) predicted abnormality information indicating an abnormality predicted to occur when the electronic control system receives the predicted attack, and (iii) predicted abnormality location information indicating a location within the electronic control system where the predicted abnormality occurs,
the attack analysis method comprising:
acquiring a security log indicating an abnormality detected in the electronic control system and a location within the electronic control system where the abnormality is detected;
estimating the attack received by the electronic control system based on the security log and the attack abnormality relationship information;
analyzing an estimation accuracy of the attack received by the electronic control system based on context data included in the security log; and
outputting attack information, which indicates the estimated attack, and estimation accuracy information, which indicates the estimation accuracy of the attack.

15. A computer-readable non-transitory storage medium storing an attack analysis program, the attack analysis program comprising instructions to be executed by a computer of an attack analysis device for analyzing an attack on an electronic control system mounted on a moving object, the attack analysis device including an attack abnormality relationship information storage, which stores attack abnormality relationship information indicating a relationship among (i) predicted attack information indicating an attack predicted to be received by the electronic control system, (ii) predicted abnormality information indicating an abnormality predicted to occur when the electronic control system receives the predicted attack, and (iii) predicted abnormality location information indicating a location within the electronic control system where the predicted abnormality occurs,
the instructions of attack analysis program comprising:
acquiring a security log indicating an abnormality detected in the electronic control system and a location within the electronic control system where the abnormality is detected;
estimating the attack received by the electronic control system based on the security log and the attack abnormality relationship information;
analyzing an estimation accuracy of the attack received by the electronic control system based on context data included in the security log; and
outputting attack information, which indicates the estimated attack, and estimation accuracy information, which indicates the estimation accuracy of the attack.
